(19) United States
(12) Patent Application Publication
(10) Pub. No.: US 2025/0034822 A1
(43) Pub. Date: Jan. 30, 2025

(54) PET WASTE VACUUMING COLLECTION AND DISPOSAL APPARATUS

(71) Applicant: Ronald Saunders II, Delaware, OH (US)

(72) Inventor: Ronald Saunders II, Delaware, OH (US)

(21) Appl. No.: 18/226,575

(22) Filed: Jul. 26, 2023

(51) Int. Cl. E01H 1/00; A01K 23/00; A47L 5/24; A47L 7/00; A47L 9/00; A47L 9/14; A47L 9/24; A47L 9/28; A47L 9/32; B02C 18/22; E01H 1/08

(52) U.S. Cl. CPC E01H 1/006; A01K 23/005; A47L 5/24; A47L 7/0085; A47L 9/009; A47L 9/1418; A47L 9/1427; A47L 9/244; A47L 9/2857; A47L 9/2884; A47L 9/322; B02C 18/2225; E01H 1/0827

(57) ABSTRACT

A pet waste vacuuming collection and disposal apparatus for collecting and disposing of animal feces includes a handle attached to a mulching mechanism that is capable of shredding animal feces into a plurality of crumb particles. The mulching mechanism includes a housing with an exhaust hole providing access to an interior space of the housing. A motor, vacuum blower, and mulching blade are mounted within the housing. A disposable bag may be removably attached to the exhaust hole. A tube extends from the housing opposite the handle. When the motor is activated, the vacuum blower suctions animal feces up through the tube, into the mulching blade, and out of the exhaust hole, where the shredded feces particles are collected in the disposable bag.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vacuums and more particularly pertains to a new vacuum for collecting and disposing of animal feces.

### (2) Description of Related Art Including Information Disclosed Under 37 CFR 1.97 and 1.98.

The prior art relates to vacuums. Some prior art vacuums have been adapted for the collection and disposal of animal feces. Other prior art examples disclose portable vacuum devices with internal mulching blades for cutting up debris that is suctioned into the vacuum. However, the prior art lacks a disclosure of a portable vacuum configured to suction and mulch animal feces without requiring the user to bend over.

### BRIEF SUMMARY OF THE INVENTION

An embodiment of the disclosure meets the needs presented above by generally comprising a handle attached to a mulching mechanism that is capable of shredding animal feces into a plurality of crumb particles. The mulching mechanism includes a housing with an exhaust hole providing access to an interior space of the housing. A motor, vacuum blower, and mulching blade are mounted within the housing. A disposable bag may be removably attached to the exhaust hole. A tube extends from the housing opposite the handle. When the motor is activated, the vacuum blower suctions the animal feces up through the tube, into the mulching blade, and out of the exhaust hole, where the shredded feces particles are collected in the disposable bag.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a pet waste vacuuming collection and disposal apparatus according to an embodiment of the disclosure.

FIG. 2 is a front view of an embodiment of the disclosure.

FIG. 3 is a back view of an embodiment of the disclosure.

FIG. 4 is a side view of an embodiment of the disclosure.

FIG. 5 is an in-use view of an embodiment of the disclosure.

FIG. 6 is a cross-sectional view of an embodiment of the disclosure.

### DETAILED DESCRIPTION OF THE INVENTION

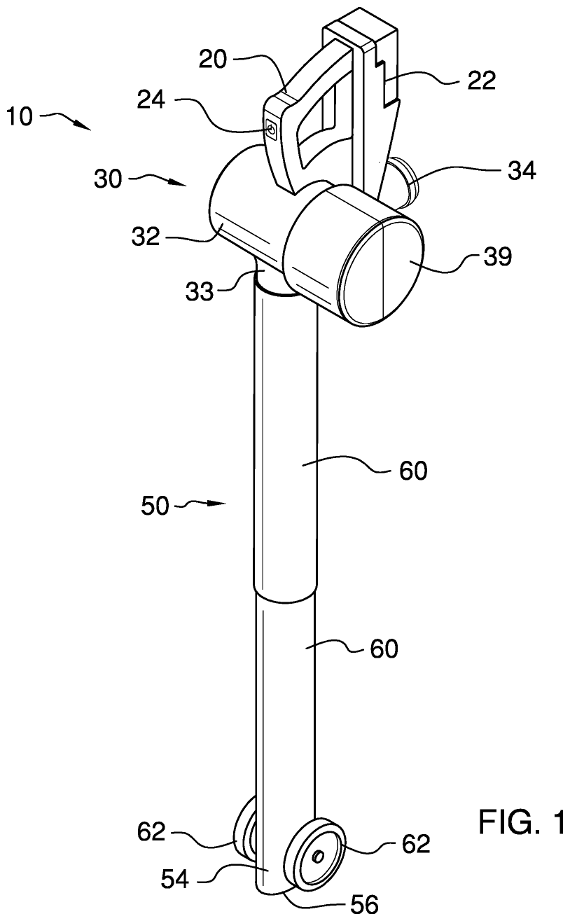

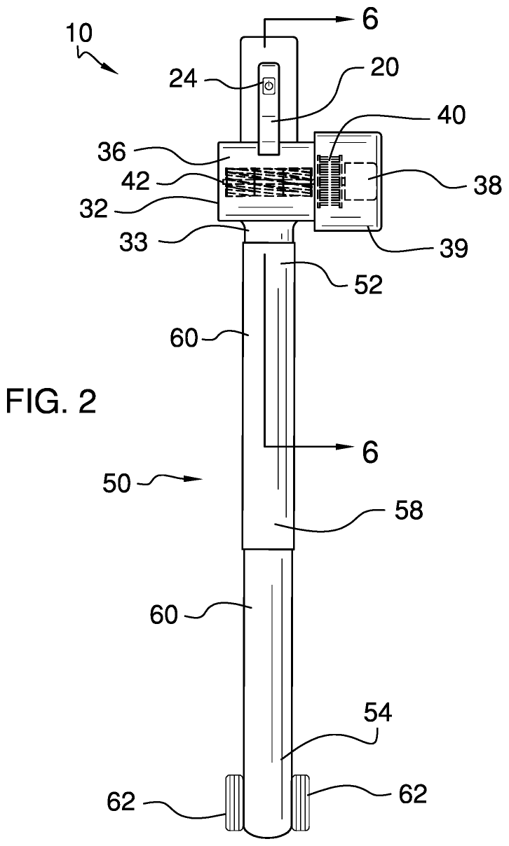

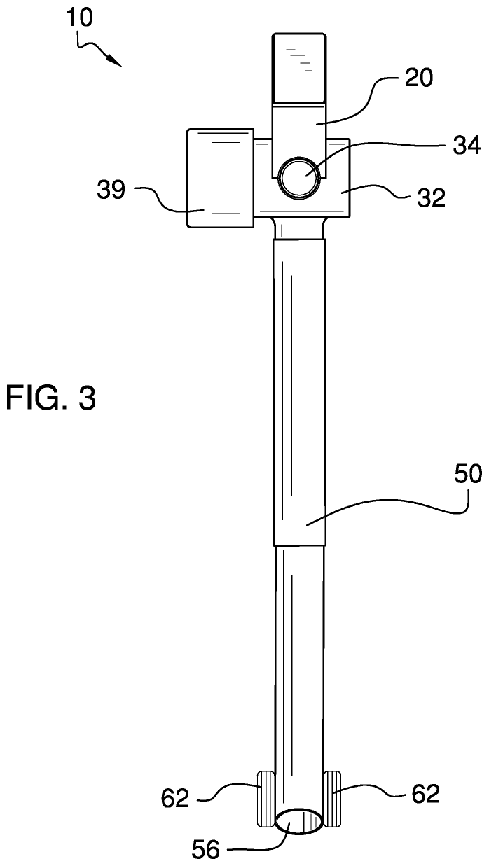

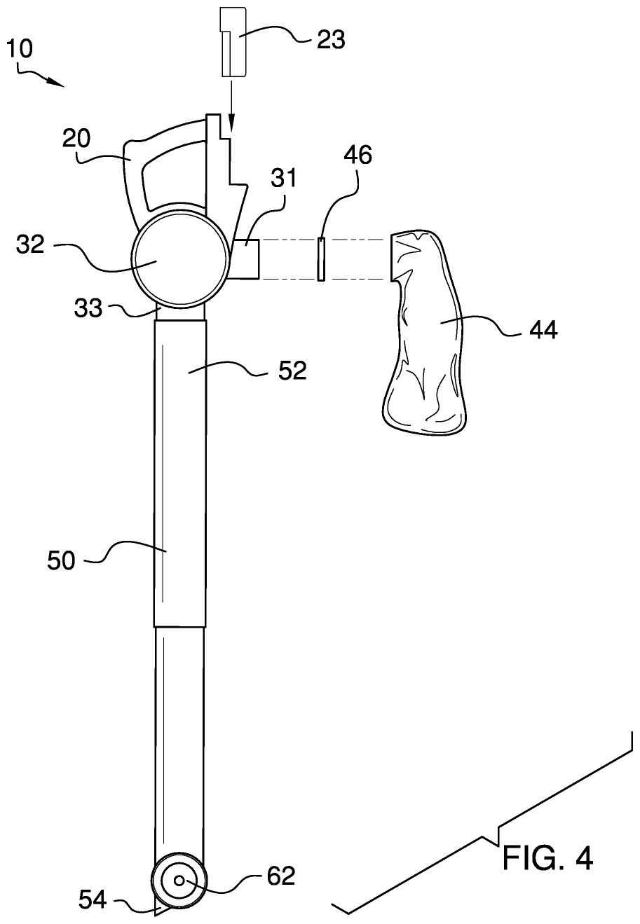

With reference now to the drawings, and in particular to FIGS. 1 through 6 thereof, a new vacuum embodying the principles and concepts of an embodiment of the disclosure and generally designated by the reference numeral 10 will be described.

As best illustrated in FIGS. 1 through 6, the pet waste vacuuming collection and disposal apparatus 10 generally comprises a handle 20 attached to a mulching mechanism 30. The mulching mechanism 30 is capable of shredding animal feces 12 into a plurality of crumb particles 14. The mulching mechanism 30 includes a housing 32 with an exhaust hole 34 providing access to an interior space 36 of the housing 32. A motor 38, vacuum blower 40, and mulching blade 42 are mounted within the housing 32. A disposable bag 44 may be removably attached to the exhaust hole 34. A tube 50 extends from the housing 32 opposite the handle 20. When the motor 38 is activated, the vacuum blower 40 suctions the animal feces 12 up through the tube 50, into the mulching blade 42, and out of the exhaust hole 34, where the shredded feces particles 14 are collected in the disposable bag 44.

The handle 20 is configured for being gripped by a user 18. A power source 22 is attached to the handle 20. For example, the power source 22 may comprise a rechargeable battery 23. However, any appropriate power source mechanism may be used. A power button 24 is electrically coupled with the power source 22. In embodiments, the power button 24 is affixed to the handle 20.

The mulching mechanism 30 is configured for shredding the animal feces into a plurality of crumb particles. In embodiments of the mulching mechanism 30, the housing 32 is affixed to the handle 20. The exhaust hole 34 is formed within the housing 32 and provides access to the interior space 36 of the housing 32.

The motor 38 is mounted within the interior space 36. The motor 38 is operably coupled with the power source 22 and is generally activated and deactivated by manipulation of the power button 24. The vacuum blower 40 is also mounted within the interior space 36 and is operably connected to the motor 38. The mulching blade 42 may also be mounted within the interior space 36 and is operably connected to the motor 38 proximate the vacuum blower 40. In particular embodiments, the vacuum blower 40 is opposite the mulching blade 42 from the exhaust hole 34.

In some embodiments, the housing 32 may further include a motor access port 37 that provides access to the interior space 36 where the motor 38 and the vacuum blower 40 are mounted. The motor access port 37 may be covered by a motor cap 39 that is removably fitted over the motor access port 37. In such embodiments, the user may remove the motor cap 39 for easy access to the motor 38 and the vacuum blower 40, for example for cleaning, maintenance, or other repairs.

The waste container 44 is removably attached to the exhaust hole 34. For example, the waste container 44 may comprise a plastic bag 44 that is configured for disposal after a single use. The waste container collects the plurality of crumb feces particles 14 after the mulching blade 42 shreds the animal feces 12.

The tube 50 is attached to the housing 32 opposite the handle 20. The tube 50 has an outflow end 52 that is proximate the housing 32 and an intake end 54 that is opposite the outflow end 52. The intake end 54 has an opening 56 that provides access to an interior channel 58 extending through the tube 50. The interior channel 58 is in fluid communication with the exhaust hole 34.

In some embodiments, the tube 50 may include a plurality of nested sections 60 such that a length of the tube 50 is adjustable. For example, the plurality of nested sections may be collapsed to shorten the length of the tube 50, which shortens a length of the interior channel 58. Alternatively, the plurality of nested sections 60 may be extended to lengthen the length of the tube 50 and the interior channel 58. With the plurality of nested sections 60, the user 18 can adjust the height of the apparatus 10 for easier use or to better achieve a particular purpose.

A pair of wheels 62 may also be attached to the intake end 54. The pair of wheels 62 may be laterally displaced with respect to one another across the tube 50. The pair of wheels 62 may make the apparatus 10 easier to move along the ground, floor, or other surface from which the user 18 is collecting the animal feces 12.

In some embodiments, such as those depicted in FIGS. 1-6, the housing 32 has a circular cross section with a first leg 31 and a second leg 33. The first leg 31 generally extends vertically and downwardly away from the handle 20 and is engageable with the outflow end 52 of the tube 50. The second leg 33 generally extends horizontally and outwardly away from the handle 20 and the exhaust hole 34 is positioned on the second leg 33.

The vacuum blower 40 is configured to create a suction force that pulls the animal feces 12 from the intake end 54, through the interior channel 58 of the tube 50, and into the mulching blade 42. The mulching blade 42 can then shred the animal feces 12 into the plurality of crumb particles 14. The vacuum blower 40 is further configured to blow the plurality of crumb particles 14 out of the exhaust hole 34 into the waste container 44.

Some embodiments may also include a bag clamp 46. The bag clamp 46 is engageable to the exhaust hole 34, wherein the bag clamp 46 is configured for securing the waste container 44 to the exhaust hole 34. The bag clamp 46 holds the waste container 44 firmly in place over the exhaust hole 34 while the animal feces 12 is directed into the waste container 44.

As indicated above, certain embodiments may have adjustable heights to accommodate a range of heights for users or a range of particular applications. In one example, the apparatus 10 has a height ranging between 3½ feet and 5 feet. The tube 50 is generally long enough to permit a user to walk the apparatus 10 over the ground or other surface without bending over. In embodiments including the plurality of nested sections 60, the user can adjust the height of the apparatus 10 based on their personal preference and comfort. The pair of wheels 62 also improves the performance of the apparatus 10 as the user pushes it along the ground, again reducing or eliminating the need for the user to bend over to clean up the animal feces.

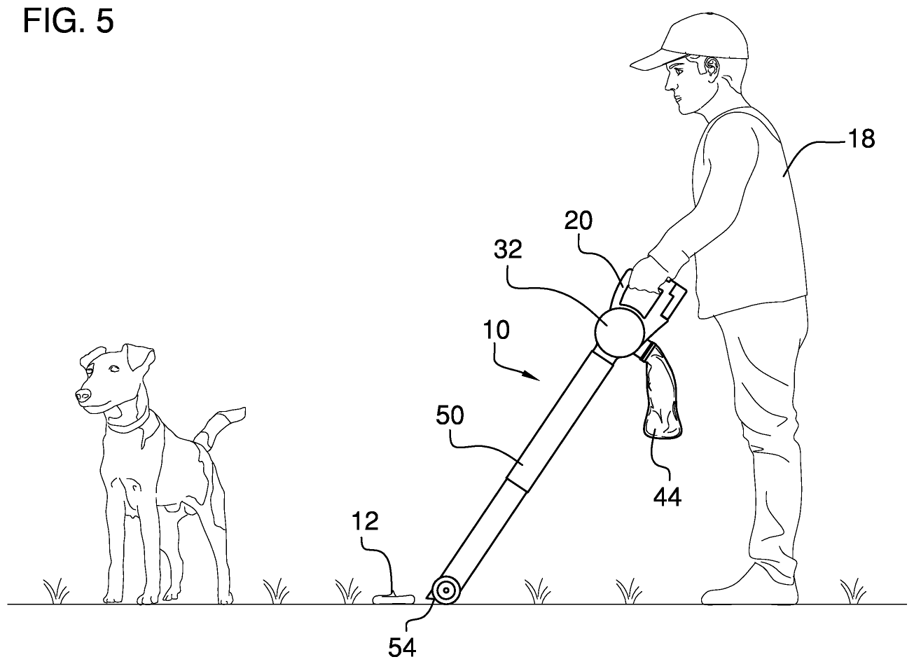

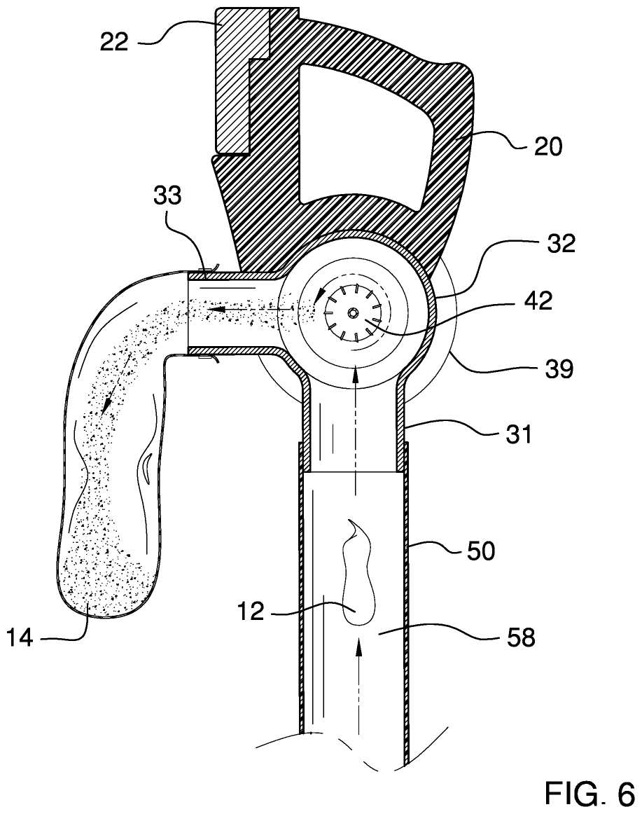

In use, as shown in FIG. 5, the user 18 pushes the apparatus 10 along the ground toward the animal feces 12. The user activates the motor 38 by manipulating the power button 24 so that the vacuum blower 40 is activated to suction, or vacuum, the animal feces 12 through the intake end 54, up the interior channel 58 of the tube 50, and into the housing 32. As shown in FIG. 6, once inside the housing 32, the animal feces 12 makes physical contact with the mulching blade 24, which shreds the animal feces 12 into a plurality of crumb particles 14. The vacuum blower 40 then directs the plurality of crumb particles 14 out of the exhaust hole 34 and into the waste container 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vacuum and disposal apparatus configured for retrieving and disposing of animal feces, the vacuum and disposal apparatus comprising:
a handle being configured for being gripped by a user;
a power source attached to the handle;
a power button being electrically coupled with the power source, the power button being affixed to the handle;
a mulching mechanism being configured for shredding the animal feces into a plurality of crumb particles, the mulching mechanism including:
a housing affixed to the handle, the housing having an exhaust hole therein providing access to an interior space;
a motor being mounted within the interior space, the motor being operably coupled with the power source;
a vacuum blower being mounted within the interior space and being operably connected to the motor;
a mulching blade being mounted within the interior space and being operably connected to the motor proximate the vacuum blower;
the vacuum blower being opposite the mulching blade from the exhaust hole;
a waste container removably attached to the exhaust hole; and
a tube attached to the housing opposite the handle, the tube having an outflow end proximate the housing and an intake end opposite the outflow end, the intake end having an opening therein configured to provide access to an interior channel extending through the tube, the interior channel being in fluid communication with the exhaust hole;
the vacuum blower being configured to create a suction force that pulls the animal feces from the intake end, through the tube, and into the mulching blade such that the mulching blade can shred the animal feces into the plurality of crumb particles, the vacuum blower being further configured to blow the plurality of crumb particles out of the exhaust hole into the waste container.

2. The vacuum and disposal apparatus of claim 1, the power source further comprising a rechargeable battery.

3. The vacuum and disposal apparatus of claim 1, wherein the waste container is a plastic bag configured for disposal after a single use.

4. The vacuum and disposal apparatus of claim 1, further comprising a bag clamp, the bag clamp being engageable to the exhaust hole wherein the bag clamp is configured for securing the waste container to the exhaust hole wherein the animal feces is directed into the waste container when the waste container is coupled to the exhaust hole.

5. The vacuum and disposal apparatus of claim 1, wherein the tube has a plurality of nested sections such that a length of the tube is adjustable.

6. The vacuum and disposal apparatus of claim 1, further comprising a pair of wheels attached to the intake end, wherein the pair of wheels are laterally displaced with respect to one another across the tube.

7. The vacuum and disposal apparatus of claim 1, wherein the motor is activated and deactivated by manipulation of the power button.

8. The vacuum and disposal apparatus of claim 1, wherein the vacuum and disposal apparatus having a height ranging between 3½ feet and 5 feet.

9. The vacuum and disposal apparatus of claim 1, wherein the housing has a circular cross-section.

10. The vacuum and disposal apparatus of claim 9, the circular cross-section further comprising:
a first leg extending vertically and downwardly away from the handle, the first leg being engageable with the outflow end of the tube; and
a second leg extending horizontally and outwardly away from the handle, the exhaust hole being positioned on the second leg.

11. A vacuum and disposal apparatus configured for retrieving and disposing of animal feces, the vacuum and disposal apparatus comprising:
a handle being configured for being gripped by a user;
a rechargeable battery attached to the handle;
a power button being electrically coupled with the power source, the power button being affixed to the handle;
a mulching mechanism being configured for shredding the animal feces into a plurality of crumb particles, the mulching mechanism including:
a housing affixed to the handle, the housing having an exhaust hole therein providing access to an interior space, the housing being formed of plastic;
a motor being mounted within the interior space, the motor being operably coupled with the rechargeable battery;
a vacuum blower being mounted within the interior space and being operably connected to the motor;
a mulching blade mounted within the interior space and being operably connected to the motor proximate the vacuum blower;
the vacuum blower being opposite the mulching blade from the exhaust hole;
a plastic bag removably coupled to the exhaust hole, the plastic bag being configured for disposal after a single use;
a bag clamp being engageable to the exhaust hole, wherein the bag clamp is configured for securing the waste container to the exhaust hole wherein the plurality of crumb particles is directed into the waste container when the waste container is coupled to the exhaust hole;
a tube attached to the housing opposite the handle, the tube having a plurality of nested sections such that a length of the tube is adjustable, the tube having an outflow end proximate the housing and an intake end opposite the outflow end, the intake end having an opening therein configured to provide access to an interior channel extending through the tube;
a pair of wheels attached to the intake end, wherein the pair of wheels are laterally displaced with respect to one another across the tube;
the motor being activated and deactivated by manipulation of the power button;
the vacuum blower being configured to create a suction force when the motor is activated that pulls the animal feces from the intake end, through the tube, and into the mulching blade such that the mulching blade can shred the animal feces into the plurality of crumb particles, the vacuum blower being further configured to blow the plurality of crumb particles out of the exhaust hole into the waste container; and
the vacuum and disposal apparatus having a height ranging between 3½ feet and 5 feet.
